(19) United States
(12) Patent Application Publication
(10) Pub. No.: US 2024/0049367 A1
(43) Pub. Date: Feb. 8, 2024

(54) COOKING APPLIANCE

(71) Applicant: LG ELECTRONICS INC., Seoul (KR)

(72) Inventors: Yunbyung CHAE, Seoul (KR); Jangmo SHIN, Seoul (KR); Sunghun SIM, Seoul (KR); Junghyeong HA, Seoul (KR); Jaepyo HONG, Seoul (KR); Chaehyun BAEK, Seoul (KR)

(73) Assignee: LG ELECTRONICS INC., Seoul (KR)

(21) Appl. No.: 18/269,500

(22) PCT Filed: Jan. 8, 2021
(86) PCT No.: PCT/KR2021/000284

§ 371 Date: Jun. 23, 2023

(30) Foreign Application Priority Data
Dec. 31, 2020 (KR) 10-2020-0189866

(51) Int. Cl. H05B 6/64

(52) U.S. Cl. CPC H05B 6/6402; H05B 6/6482

(57) ABSTRACT

A cooking appliance includes a cavity having a cooking space formed therein and an accommodation space, which is smaller than the cooking space, formed above the cooking space; a microwave generator for generating microwaves to the cooking space; a moving heater module accommodated in the accommodation space and including a heater; a moving heater module control unit for controlling the moving heater module; and a moving heater choke provided between the outer peripheral part of the moving heater module and the inner surface of the cavity.

### TECHNICAL FIELD

The present invention relates to a cooking appliance, and more particularly to a cooking appliance having a heater.

### BACKGROUND ART

As a device for cooking food, etc(hereinafter referred to as food), it can be classified into a closed type cooking device and an open type cooking device according to the shape of a space in which food is placed.

The closed type cooking device cooks food in a state in which a cooking space is shielded, such as ovens and microwave ovens,

The open type cooking device cooks food in an open space, such as a cooktop.

A microwave oven is a cooking device that uses microwaves to heat and cook food to be cooked using microwaves, molecules constituting food vibrate with microwaves, and as a result, the temperature of food rises due to frictional heat generated between the constituent molecules. do. This heating method is called dielectric heating method.

Recently, in addition to the heating method by microwave, there is an induction heating cooking combined microwave oven equipped with an induction coil as a separate heating means and capable of cooking food in a cavity by induction heating via the induction coil.

In a microwave oven equipped with a heater, it is preferable to change the position of the heater according to the type or size of food to be cooked in order to obtain an optimal cooking state.

An example of a microwave oven equipped with a heater is a method for controlling a moving heater of a microwave oven disclosed in Korean Patent Publication No. 1999-0060449 A (published on Jul. 26, 1999) and the microwave oven comprises a cavity and a moving heater installed on the side of inside the cavity to be rotatable around a support point.

Another example of a microwave oven equipped with a heater is disclosed in Korean Patent Publication No. 10-2007-0105794 A (published on Oct. 31, 2007) and the microwave comprises a first variable heater unit installed on a first surface of a cavity of a microwave oven to heat an object to be cooked, and rotated to a second surface adjacent to the first surface by a first rotating device; a second variable heater unit installed on a first surface of the cavity, spaced apart from the first variable heater unit, and rotated to a third surface adjacent to the first surface by a second rotating device; and a third variable heater that is installed on a fourth surface facing the first surface and spaced apart from the second variable heater unit to heat a cooking object, and is rotated to a fifth surface adjacent to the fourth surface by a third rotating device.

### DISCLOSURE

### Technical Problem

An object of the present invention is to provide a cooking appliance capable of minimizing leakage of electromagnetic waves to a moving heater module controller that controls the moving heater module.

### Technical Solution

The cooking appliance according to an embodiment of the present invention comprises a cavity in which a cooking space is formed and an accommodation space formed above the cooking space, the accommodation space smaller than the cooking space; a microwave generator generating microwaves into the cooking space; a moving heater module accommodated in the accommodation space and comprising a heater; and a moving heater module control unit for controlling the moving heater module.

The moving heater module controller is disposed in the moving heater module. The moving heater module controller may be arranged in the moving heater module or above the moving heater module.

A gap is formed between an outer circumference of the moving heater module and an inner surface of the cavity. A moving heater choke for attenuating microwaves is provided in the gap.

The moving heater choke between the outer circumferential portion of the moving heater module and the inner surface of the cavity can minimize the penetration of microwaves into the moving heater module controller between the outer circumferential portion of the moving heater module and the inner surface of the cavity, can minimize damage to the moving heater module controller by microwaves.

The moving heater module may be descended from the accommodation space to the cooking space, and may more quickly provide heat to the food in the cooking space in a state close to the food.

The moving heater module is accommodated in the accommodation space when not in use, and the space utilization of the cooking space is high.

The cavity comprises; a main cavity in which the cooking space is formed; an upper cavity disposed above the main cavity.

An accommodation space is formed inside of the upper cavity and an opening an opening is formed above the accommodation space.

The moving heater module further comprises a housing disposed in the opening. The moving heater module comprises a driving source disposed in the housing; a moving heater including the heater; and a link connected to the moving heater and rotated when the driving source is driven.

The housing may be configured as a separate component from the upper cavity, and mounting of the moving heater module is easier than when the housing is integrated with the upper cavity.

The moving heater may be moved up and down by a link, and may comprise a moving body, a heater porous body and glass.

The moving body is connected to the link and a heater space in which a heater is accommodated may be formed.

The heater porous body is disposed below the heater to block electromagnetic waves to the heater.

The glass may be disposed under the heater porous body.

The moving heater choke may be disposed separately from the heater porous body and spaced apart from the heater porous body. The heater may be protected by a heater porous body, and the moving heater module controller may be protected by a moving heater choke.

A gap accommodating the moving heater choke may be formed between the outer circumference of the housing and the upper cavity.

The gap becomes a passage through which the microwaves can pass, and the moving heater choke accommodated in the gap can attenuate the microwaves passing through the gap.

An example of a moving heater choke may be disposed on a housing. The moving heater choke may be spaced apart from the upper cavity.

Another example of a moving heater choke may be placed in the upper cavity. The moving heater choke may be spaced apart from the moving heater module, particularly the housing.

The moving heater choke may have a through hole through which the moving heater module passes.

The through hole of the moving heater choke may surround the moving heater module, and it is possible to minimize penetration of microwaves through an outer circumferential portion of the moving heater module.

The moving heater choke may comprise a horizontal plate disposed horizontally in the gap, and a choke body extending upward from the horizontal plate and formed with the choke.

The horizontal plate of the moving heater choke is disposed horizontally in the gap, so that the penetration of foreign substances can be minimized.

### Advantageous Effect

According to an embodiment of the present invention, the moving heater choke can minimize the penetration of microwaves into the moving heater module controller between the outer circumference of the moving heater module and the inner surface of the cavity, and damage to the moving heater module controller by microwaves can be minimized.

In addition, the moving heater module is lowered from the accommodating space to the cooking space and can heat the food more quickly in a state in which it is disposed close to the food in the cooking space, when the moving heater module is not in use, the moving heater module is accommodated in the accommodation space, so the space utilization of the cooking space is high.

In addition, since the housing is composed of a separate component from the upper cavity, mounting of the moving heater module is easier than when the housing is integrated with the upper cavity.

In addition, the heater can be protected by the porous heater network, and the moving heater module controller can be protected by the moving heater choke.

In addition, the moving heater choke is accommodated in the gap formed between the outer circumferential portion of the housing and the upper cavity, so that penetration of microwaves through the gap can be minimized.

In addition, the moving heater choke may be disposed in a housing or an upper cavity so as to minimize penetration of microwaves together with a heater porous body disposed below the heater.

In addition, the through hole of the moving heater choke may surround the moving heater module, and penetration of microwaves through an outer circumferential portion of the moving heater module may be minimized.

In addition, since the horizontal plate of the moving heater choke is disposed horizontally in the gap, penetration of foreign substances can be minimized.

### DESCRIPTION OF DRAWINGS

FIG. 1 is a perspective view when a cooking space of a cooking appliance according to an embodiment is opened;

FIG. 2 is a view schematically showing the inside of the cooking appliance according to the present embodiment;

FIG. 3 is a partially cut-away perspective view showing an example of a moving heater module and a moving heater choke according to this embodiment;

FIG. 4 is a perspective view showing various examples of a moving heater choke according to this embodiment;

FIG. 5 is a perspective view showing an example of a moving heater module according to the present embodiment;

FIG. 6 is a partially cut-away perspective view of the moving heater module shown in FIG. 5;

FIG. 7 is an exploded perspective view in which the moving heater module, cavity, and moving heater choke shown in FIG. 6 are separated;

FIG. 8 is a graph showing electromagnetic shielding analysis results when a moving heater choke according to the present embodiment is disposed in a moving heater module;

FIG. 9 is a perspective view showing another example of a moving heater module according to this embodiment;

FIG. 10 is a partially cut-away perspective view of the moving heater module shown in FIG. 9;

FIG. 11 is an exploded perspective view in which the moving heater module, cavity, and moving heater choke shown in FIG. 10 are separated.

### BEST MODE

Hereinafter, specific embodiments of the present invention will be described in detail with drawings.

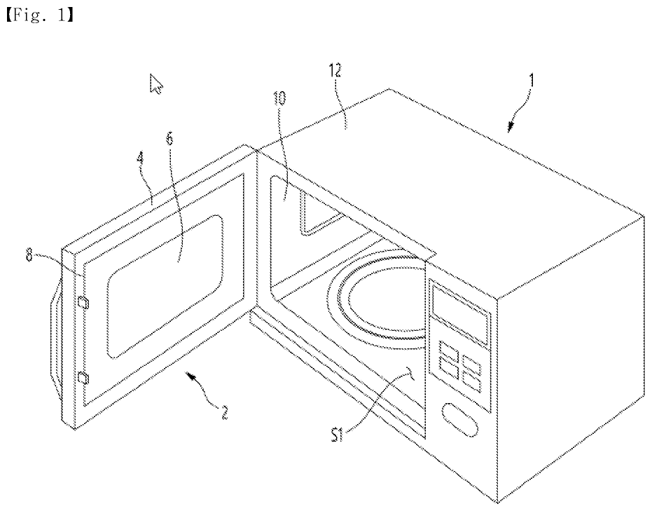

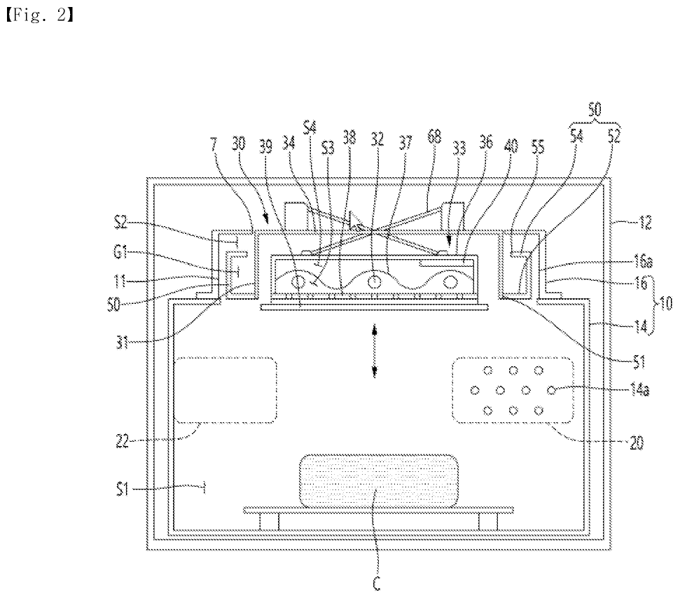

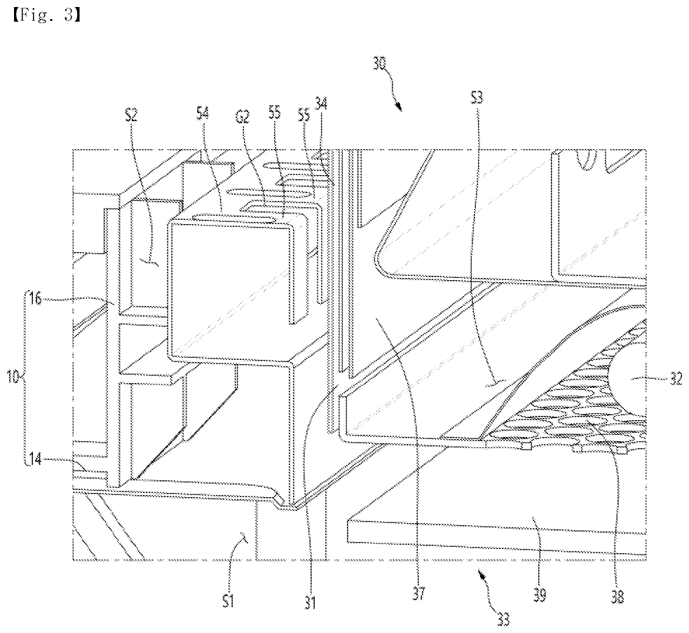

FIG. 1 is a perspective view when a cooking space of a cooking appliance according to an embodiment is opened; FIG. 2 is a view schematically showing the inside of the cooking appliance according to the present embodiment; FIG. 3 is a partially cut-away perspective view showing an example of a moving heater module and a moving heater choke according to this embodiment.

The cooking appliance may comprise a main body 1 in which a cooking space S1 (cooking chamber) is formed, and a door 2 rotatably connected to the main body 1 to open and close the cooking space S1.

The front of the main body 1 may be open, and the cooking space S1 may be formed inside the main body 1.

The door 2 may open and close the cooking space S1 in front of the main body 1. The door 2 includes a door body 4 rotatably formed on a main body 1 and having an opening in the center, a viewing window 6 disposed in the opening, and a door chock 8 disposed on the door body 4. The door choke 8 can minimize the leakage of microwaves between the door 2 and the main body 1.

The main body 1 may comprise a cavity 10 in which a cooking space S1 is formed, and a case 12 surrounding the cavity 10 from the outside of the cavity 10. The case 12 may form an exterior of the cooking appliance.

The cavity 10 may be formed in a three-dimensional shape. The cavity 10 may have a cooking space S1 formed therein, and as shown in FIG. 2, an accommodation space S2 smaller in size than the cooking space S1 may be formed above the cooking space S1.

The cooking space S1 may be a space in which food C is accommodated.

The accommodating space S2 may be a space in which the moving heater module 30 is accommodated. The accommodating space (S2) may be formed on the upper side of the cooking space (S1) to communicate with the cooking space (S1).

The cavity 10 may include a main cavity 14 and an upper cavity 16.

A cooking space S1 may be formed inside the main cavity 14.

The upper cavity 16 may be disposed above the main cavity 14. The upper cavity 16 may be manufactured as a separate component from the main cavity 14 or formed integrally with the main cavity 14.

An accommodation space S2 may be formed inside the upper cavity 16.

The upper cavity 16 may comprise a circumferential wall and a top plate.

The circumferential wall may surround the moving heater module 30, and the accommodating space S2 may be a space formed inside the circumferential wall.

The upper plate may be formed at an upper end of the circumferential wall and may be orthogonal to the circumferential wall.

The upper cavity 16 may have an opening 17 formed above the accommodating space S2. The opening 17 may be formed on an upper plate of the upper cavity 16. The opening 17 may be formed on the upper plate of the upper cavity 16 to be open in a vertical direction.

The cooking appliance may comprise a microwave generator 20 that generates microwaves into the cooking space S1. The microwave generator 20 may be disposed outside the cavity 10 and generate electromagnetic waves into the cooking space S1 through the through hole 14a to be formed in the cavity 10. An example of a microwave generator 20 may be a magnetron.

The cooking appliance may include a power supply 22. The power supply 22 may supply power to the magnetron and the heater 32.

The cooking appliance may include a moving heater module 30 and a moving heater module controller 40 that controls the moving heater module 30.

The moving heater module 30 may be accommodated in the accommodation space S2. The whole of the moving heater module 30 can be accommodated in the accommodating space S2, and a portion of the moving heater module can be accommodated in the accommodating space S2.

The moving heater module 30 may descend from the accommodation space S2 to the cooking space S1, and in a state in which it is disposed close to the food C in the cooking space S1, the moving heater module 30 can provide heat to the food C more quickly.

The moving heater module 30 is accommodated in the accommodating space S2 when not in use, and the space utilization of the cooking space S1 is high.

The moving heater module 32 may further include a heater 32.

The heater 32 may be a heat generating source that generates heat when power is applied. Examples of the heater 32 include electric heaters, lamps, ect.

The moving heater module controller 40 may include a circuit for controlling the heater 32, and the circuit for controlling the heater 32 may be formed on a circuit board or a flexible circuit board.

The moving heater module controller 40 may be disposed in the moving heater module 30 or in the cavity 10.

It is preferable that the moving heater module controller 40 is electrically connected to the heater 32 through a cable or the like and disposed close to the heater 32.

The moving heater module controller 40 may be disposed inside the moving heater module 30, above the moving heater module 30, or above the cavity 10.

The moving heater module 30 may further comprise a housing 34 disposed in the opening 17.

The housing 34 may form the exterior of the moving heater module 30 and may be a moving heater housing.

The housing 34 may have a box shape with an open bottom. A space in which a moving body 33 to be described later is accommodated may be formed inside the housing.

The outer circumferential portion of the housing 34 may be the outer circumferential portion 11 of the moving heater module 30. Hereinafter, the outer circumferential portion of the housing 34 and the outer circumferential portion of the moving heater module 30 are the same reference.

The moving heater module 30 may comprise a moving heater 33, and the moving heater 33 may comprise a heater 32.

The moving heater 33 may further include a moving body 36.

A link 68 may be connected to the moving body 36. A connection portion to which a lower portion of the link 68 is rotatably connected may be formed at an upper portion of the moving body 36. The moving body 36 may be moved up and down by the link 68 when the link 68 rotates.

The moving body 36 may form a space in which the heater 32 is accommodated. The space can be formed inside the moving body 36, and the heater space S3 can be formed between the housing 34 and the moving body 36.

The heater 32 may be fixedly disposed on the moving body 36 and may move along with the moving body 36. A heater connection portion to which the heater 32 is connected may be disposed on the moving body 36.

An example of the moving heater module controller 40 may be disposed fixedly on the moving body 36, and in this case, the moving heater module controller 40 may move together with the moving body 36.

Another example of the moving heater module controller 40 may be disposed fixedly to the housing 34.

The moving heater 33 may comprise a reflector 37 that reflects heat generated by the heater 32 toward the cooking space S1. The reflector 37 may have a periphery of the heater 32 and the periphery of the heater 32 may be formed in a curved shape. The reflector 37 may be disposed across the moving body 36.

The moving heater 33 may form a heater space S3 below the reflector 37 and an upper space S4 may be formed above the reflector 37.

The reflector 37 may partition the heater space S3 and the upper space S4. Heat generated in the heater 32 is reflected by the reflector 37, and damage to the moving heater module controller 40 caused by the heat of the heater 32 can be minimized.

The moving heater 33 may further comprise a heater porous body 38 and a glass 39.

The heater porous body 38 is disposed below the heater 32 to block electromagnetic waves to the heater 32. The heater porous body 38 may be installed under the moving body 36 and spaced apart from the heater 32. The heater porous body 38 may face the heater 32 and the reflector 37 from the lower side of the heater 32. Microwaves generated by the microwave generator 20 may be introduced in the direction of the heater 32 in the cooking space S1, but the heater porous body 38 may minimize the penetration of these microwaves.

The glass 39 may be disposed under the heater porous body 38. The glass 36 can prevent the heater 32 or the heater porous body 38 from being contaminated by steam or foreign substances generated from the food C.

The cooking appliance may comprise a moving heater choke 50. The moving heater choke 50 may be provided between the outer circumferential portion 31 of the moving heater module 30 and the inner surface 11 of the cavity 10.

The moving heater choke 50 can prevent electromagnetic waves in the cooking space S1 from penetrating into the moving heater module 30, prevent electromagnetic waves in the cooking space S1 from penetrating into the upper portion of the moving heater module 30 and prevent electromagnetic waves in the cooking space S1 from penetrating into the moving heater module 30 when the microwave generator 20 operates.

The moving heater choke 50 may be disposed separately from the heater porous body 38 and spaced apart from the heater porous body 38.

In the cooking appliance, a gap G1 may be formed between the moving heater module 30 and the cavity 10.

The gap G1 may be formed between the outer circumferential portion 31 of the housing 34 and the upper cavity 16. The gap G1 may open between the outer circumferential portion 31 of the housing 34 and the upper cavity 16 in a vertical direction.

The moving heater choke 50 may be accommodated in this gap G1.

If there is no moving heater choke 50, electromagnetic waves in the cooking space S1 can pass between the inner surface 11 of the cavity 10 and the outer circumferential portion 31 of the moving heater module 30, and electromagnetic waves can penetrate into the module control unit 40.

Here, the inner surface 11 of the cavity 10 may be defined as a surface facing the outer circumferential portion 31 of the moving heater module of in the cavity 10. The inner surface 11 of the cavity 10 may be a portion of the upper cavity 16 and may be an inner surface of a vertical plate 16a formed long in the vertical direction of the upper cavity 16.

The moving heater choke 50 may be disposed to surround the outer circumferential portion 31 of the moving heater module 30. A through hole 51 through which the moving heater module 30 passes may be formed. The through hole 51 of the moving heater choke 50 may surround the moving heater module 30, particularly the outer circumferential portion 31 of the housing 34.

The moving heater choke 50 may include a horizontal plate 52 and a choke body 54.

The horizontal plate 52 may be horizontally disposed in the gap G1. The horizontal plate 52 may be disposed to cover a portion of the gap G1. The through hole 51 may be formed in the horizontal plate 52.

The choke body 54 may extend upward from the horizontal plate 52. A choke 55 may be formed in the choke body 54. The choke 55 may be formed on top of the choke body 54.

A plurality of chokes 55 may be formed on the choke body 54, and the plurality of chokes 55 may be spaced apart from each other in a horizontal direction, as shown in FIG. 3. A gap G2 may be formed between two adjacent chokes among the plurality of chokes 55. The cross-sectional shape of each choke 55 may be ‘¬’ shape.

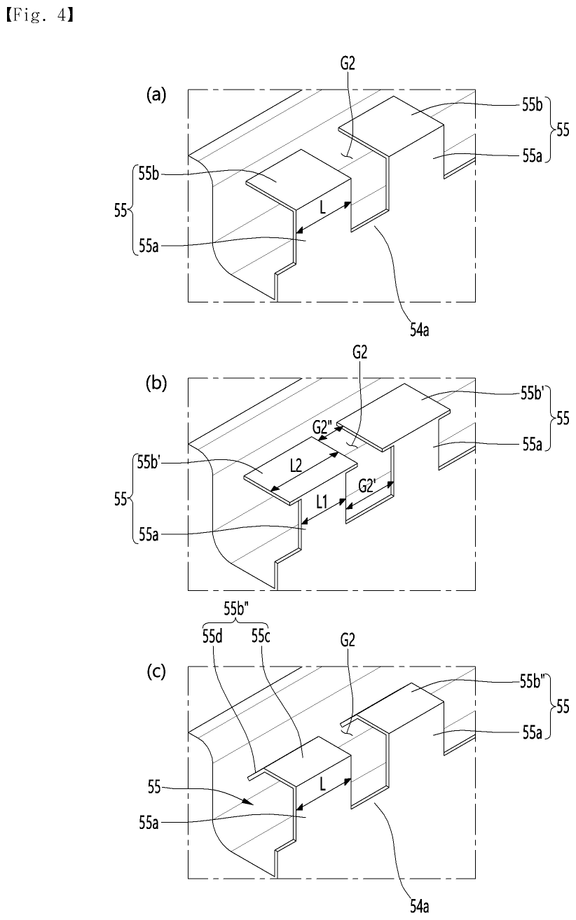

FIG. 4 is a perspective view showing various examples of a moving heater choke according to this embodiment;

The choke body 54 of the moving heater choke 50 may comprise, as shown in FIGS. 4(a), 4(b) and 4(c), a body 54a and a plurality of chokes 55 protruding from the body 54a, and a plurality of chokes 55 are spaced apart from each other.

As an example of the choke 55, as shown in (a) of FIG. 4, the cross-sectional shape of a plurality of chokes 55 may be formed in an ‘¬’ shape. Each of the chokes 55 may comprise a first choke 55a extending to protrude from the body 54a and a second choke 55b bent from the first choke 55a perpendicularly to the first choke 55a and a width L of the first choke 55a and the second choke 55b may be the same.

As another example of the choke 55, as shown in (b) of FIG. 4, the cross-sectional shape of a plurality of chokes 55 may be formed in an ‘¬’ shape, and each of the chokes 55 may comprise a first choke 55a extending to protrude from the body 54a and a second choke 55b′ bent from the first choke 55a perpendicularly to the first choke 55a and widths L1 and L2 of the first choke 55a and the second choke 55b′ may be different. A width L2 of the second choke 55b′ may be longer than a width L1 of the first choke 55a. Another example of choke 55 may be a thin choke.

Each of the first chokes 55a may be spaced apart from the first chokes 55a of adjacent chokes 55 with a first gap G2′. Each of the second chokes 55b′ may be spaced apart from the second chokes 55b′ of adjacent chokes 55 with a second gap G2″. The first gap G2′ may be larger than the second gap G2″.

As another example of the choke 55 is shown in (c) of FIG. 4, each of the chokes 55 comprise a first choke 55a in which each of the chokes 55 protrudes from the body 54a, and a second choke 55b″ formed in a two-stage bent shape in the first choke 55a and the width L of the first choke 55a and the second choke 55b′ may be the same. The second choke 55b″ comprise a first bent portion 55c bent orthogonally at the first choke 55a and a second bent portion 55d bent at an angle to the first bent portion 55c. The second bent portion 55d may be inclined at an angle from the first bent portion 55c and greater than 90° and less than 180°. Another example of the choke 55 may be a two-stage bent choke.

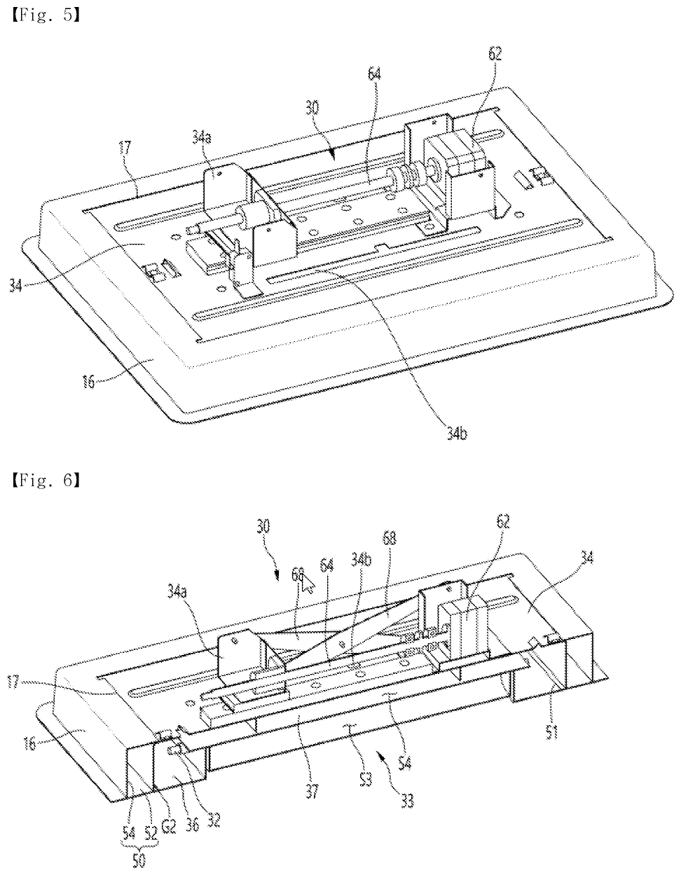

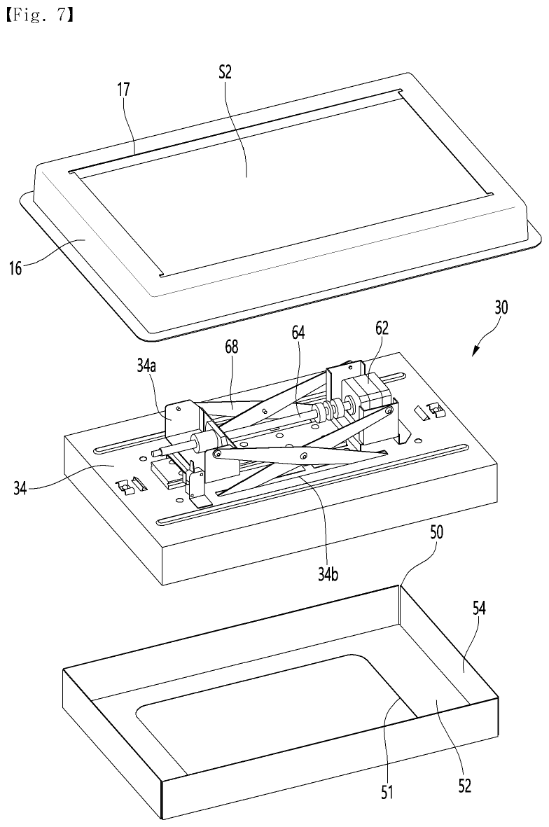

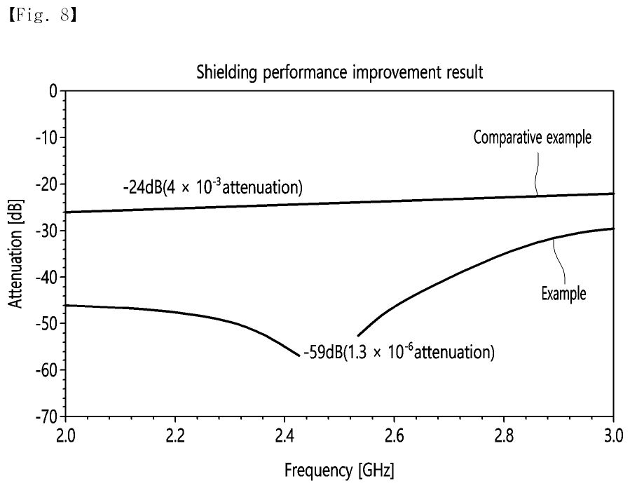

FIG. 5 is a perspective view showing an example of a moving heater module according to the present embodiment; FIG. 6 is a partially cut-away perspective view of the moving heater module shown in FIG. 5; FIG. 7 is an exploded perspective view in which the moving heater module, cavity, and moving heater choke shown in FIG. 6 are separated.

The moving heater module 30 may include a driving source 62, at least one power transmission member 64, a moving heater 33 including the heater 32, and a link 68.

The moving heater 33 may comprise a heater 32 and may be moved up and down by a link 68.

The driving source 62 may be disposed in the housing 34. An example of the drive source 62 may be a motor. The driving source 62 may be controlled by the moving heater module control unit 40 or may be controlled by a controller that controls overall operations of the cooking appliance.

The power transmission member 64 may transmit the driving force of the driving source 62 to the link 68. The power transmission member 64 may cause the link 68 to be rotated about the center of rotation. The power transmission member 64 is applicable regardless of its type, as long as it is configured to transmit the rotational force of the motor to the rotational force of the link 68, such as a shaft or a gear.

The link 68 is connected to the moving heater 33 and can be rotated when the driving source 62 is driven.

Link 68 may be rotatably supported on housing 34. A link connection portion 34a in which an upper portion of the link 68 is rotatably supported may be formed in the housing 34A.

A lower portion of the link 68 may be rotatably connected to the moving heater 33, in particular, the moving body 36.

The link 68 is connected to the upper of the moving heater 33 and can be operated by the power transmission member 64.

Link 68 may pass through housing 34. A through hole 34b through which the link 68 passes may be formed in the housing 34.

The moving heater choke 50 may be disposed in the moving heater module 30, in particular, the housing 34. The moving heater choke 50 may be spaced apart from the cavity 10, particularly the upper cavity 16. As shown in FIG. 6, a gap G3 may be formed between the horizontal plate 52 of the moving heater choke 50 and the moving body 36 of the moving heater 33.

FIG. 8 is a graph showing electromagnetic shielding analysis results when a moving heater choke according to the present embodiment is disposed in a moving heater module.

When the moving heater choke 50 is disposed in the moving heater module 30 according to the present embodiment, compared to the case where the moving heater choke 50 is not disposed in the moving heater module 30, approximately 59Db (1.3×10⁻⁶) reduces electromagnetic waves.

The comparative example is an example in which a heater porous body is disposed in the moving heater module 30 instead of the moving heater choke 50 of the present embodiment. If the heater porous body of the comparative example is disposed in the moving heater module 30, electromagnetic waves are reduced by approximately 24 dB (4×10⁻³) compared to the case where the heater porous body is not disposed in the moving heater module 30.

The moving heater choke 50 of this embodiment has much higher electromagnetic wave shielding performance than the heater porous body, and shows attenuation performance of about 1000 times or more.

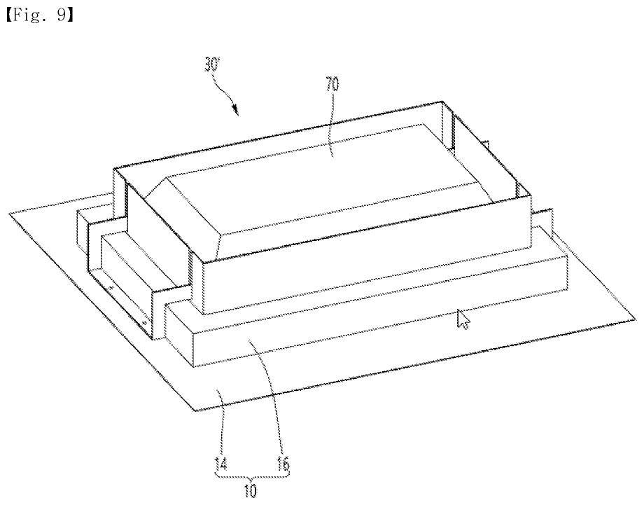

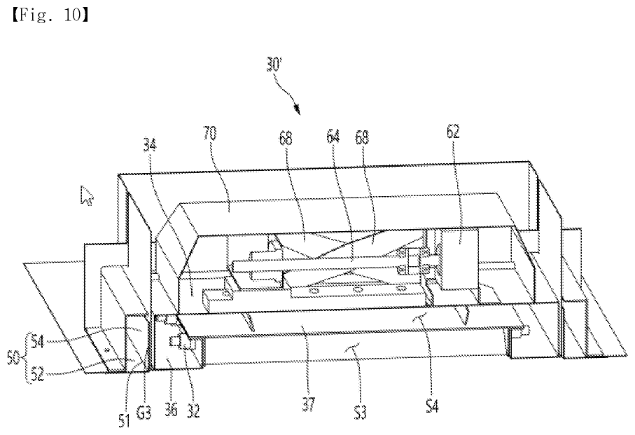

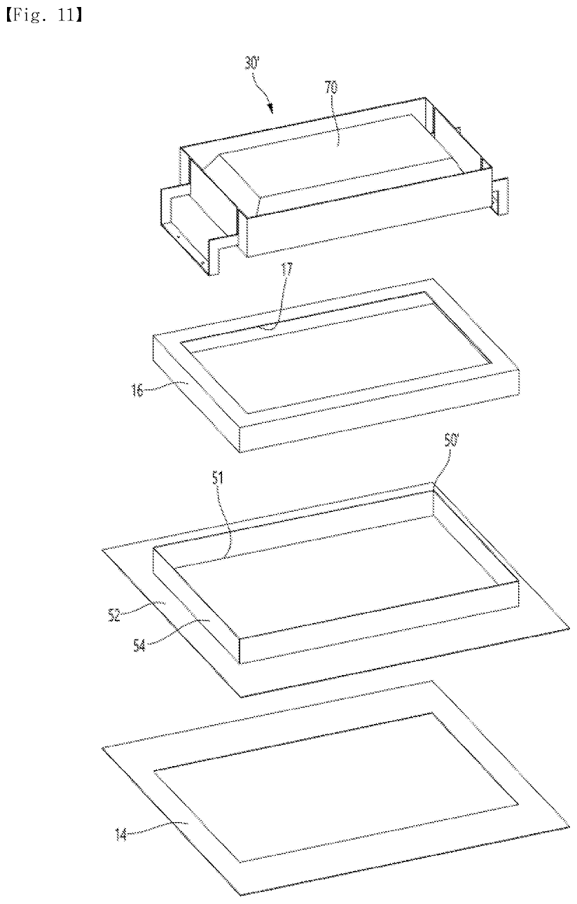

FIG. 9 is a perspective view showing another example of a moving heater module according to this embodiment; FIG. 10 is a partially cut-away perspective view of the moving heater module shown in FIG. 9; FIG. 11 is an exploded perspective view in which the moving heater module, cavity, and moving heater choke shown in FIG. 10 are separated.

Like the moving heater module shown in FIGS. 5 to 7, the moving heater module 30′ includes a moving heater 33, a housing 34, a driving source 62, a power transmission member 64, and a link 68. Since the moving heater 33, the housing 34, the drive source 62, the power transmission member 64, and the link 68 are the same as those of the moving heater module shown in FIGS. 5 to 7, and a detailed description thereof is omitted to avoid redundant description.

The moving heater module 30′ may further comprise a top cover 70. The top cover 70 may be disposed above the housing 34. The top cover 70 may cover the drive source 62, the power transmission member 64 and the link 68 at the upper side of the housing 34, and the drive source 62 and the power transmission member 64 and the link 6 can be protected.

The moving heater choke 50′ may be disposed in the upper cavity 16. The moving heater choke 50′ may be spaced apart from the moving heater module 30′, particularly the housing 34. A gap G3 may be formed between the moving heater choke 50′ and the housing 34.

The above description is merely illustrative of the technical spirit of the present disclosure, and various modifications and changes can be made by those of ordinary skill in the art, without departing from the scope of the present disclosure.

Therefore, the embodiments disclosed in the present disclosure are not intended to limit the technical spirit of the present disclosure, but are intended to explain the technical spirit of the present disclosure. The scope of the technical spirit of the present disclosure is not limited by these embodiments.

The scope of the present disclosure should be interpreted by the appended claims, and all technical ideas within the scope equivalent thereto should be construed as falling within the scope of the present disclosure.

1-11. (canceled)

12. A cooking appliance, comprising:
a cavity including:
a cooking space; and
an accommodation space located above the cooking space;
a microwave generator configured to generate microwaves into the cooking space;
a moving heater module accommodated in the accommodation space, the moving heater module including a heater;
a moving heater module controller configured to control the moving heater module; and
a moving heater choke disposed in a gap between an outer circumference of the moving heater module and an inner surface of the cavity, the moving heater choke being configured to attenuate the microwaves.

13. The cooking appliance of claim 12, wherein the moving heater module controller is disposed in the moving heater module.

14. The cooking appliance of claim 12, wherein the cavity further includes:
a main cavity in which the cooking space is formed; and
an upper cavity disposed above the main cavity, the upper cavity including:
the accommodation space; and
an opening provided above the accommodation space.

15. The cooking appliance of claim 14, wherein the moving heater module further includes a housing disposed in the opening.

16. The cooking appliance of claim 15, wherein the moving heater module further includes:
a driving source disposed on the housing;
a moving heater including the heater; and
a link connected to the moving heater and configured to be rotated when the driving source is driven.

17. The cooking appliance of claim 16, wherein the moving heater further includes:
a moving body connected to the link, the moving body forming a heater space in which the heater is accommodated;
a heater porous body disposed below the heater to block electromagnetic waves to the heater; and
a glass disposed under the heater porous body.

18. The cooking appliance of claim 15, wherein the gap is located between an outer circumference of the housing and the upper cavity, and
wherein the moving heater choke is disposed in the gap.

19. The cooking appliance of claim 15, wherein the moving heater choke is disposed on the moving heater module.

20. The cooking appliance of claim 15, wherein the moving heater choke is disposed in the upper cavity.

21. The cooking appliance of claim 15, wherein the moving heater choke includes a through hole through which the moving heater module passes.

22. The cooking appliance of claim 12, wherein the moving heater choke includes:
a horizontal plate disposed in the gap; and
a choke body extending upwards from the horizontal plate.

23. A cooking appliance, comprising:
a cavity including:
a cooking space; and
an accommodation space located above the cooking space;
a microwave generator configured to generate microwaves into the cooking space;
a moving heater module accommodated in the accommodation space, the moving heater module being configured to move into the cooking space;
a moving heater module controller configured to control the moving heater module; and
a moving heater choke provided in a gap between the moving heater module and the cavity, the moving heater choke being configured to attenuate the microwaves.

24. The cooking appliance of claim 23, wherein the moving heater module includes:
a moving heater including a heater;
a driving source;
a power transmission member; and
a link.

25. The cooking appliance of claim 24, wherein the power transmission member transmits a driving force of the driving source to the link.

26. The cooking appliance of claim 25, wherein the moving heater module further includes a housing, and
wherein the link is rotatably supported on the housing.

27. The cooking appliance of claim 26, wherein the power transmission member causes the link to be rotated to move the moving heater into or out of the cooking space.

28. The cooking appliance of claim 24, wherein the moving heater includes a reflector configured to reflect heat, generated by the heater, toward the cooking space.

29. The cooking appliance of claim 28, wherein the moving heater further includes:
a heater porous body disposed below the heater to block electromagnetic waves; and
a glass disposed below the heater porous body.

30. The cooking appliance of claim 23, wherein the moving heater choke includes:
a body; and
a plurality of chokes protruding from the body, the plurality of chokes being spaced apart from one another.

31. The cooking appliance of claim 30, wherein each choke includes a first choke protruding from the body in a first direction and a second choke protruding from the first choke in a second direction, and
wherein the second direction is different from the first direction.
